(19) United States
(12) Patent Application Publication
(10) Pub. No.: US 2025/0197311 A1
(43) Pub. Date: Jun. 19, 2025

(54) COATED FERTILIZER GRANULE COMPOSITIONS

(71) Applicant: Dow Global Technologies LLC, Midland, MI (US)

(72) Inventors: Yasmin N. Srivastava, Sugar Land, TX (US); Alex J. Kosanovich, Rosharon, TX (US); Yi Fan, Sugar Land, TX (US); Daniel G. Abebe, Lake Jackson, TX (US); Praveenkumar Boopalachandran, Rosharon, TX (US); Kanjakha Pal, Lake Jackson, TX (US); Juan Carlos Medina, Lake Jackson, TX (US)

(21) Appl. No.: 18/849,124

(22) PCT Filed: Mar. 20, 2023
(86) PCT No.: PCT/US2023/015642

§ 371 Date: Sep. 20, 2024

Related U.S. Application Data
(60) Provisional application No. 63/321,989, filed on Mar. 21, 2022.

(51) Int. Cl. C05G 5/30; C05G 3/20; C05G 3/40; C05G 5/12

(52) U.S. Cl. CPC C05G 5/37; C05G 3/20; C05G 3/40; C05G 5/12; C05G 5/38

(57) ABSTRACT

Embodiments of the present disclosure are directed towards coated fertilizer granule compositions that include two polyurethane layers and an optional wax layer.

### FIELD OF DISCLOSURE

Embodiments of the present disclosure are directed towards coated fertilizer granule compositions.

### BACKGROUND

Coatings on fertilizer granules help to control fertilizer release and reduce dust production. Controlled release of fertilizer can, among other things, increase the efficiency of the fertilizer, lower the cost of labor associated with fertilizing, and/or reduce the quantity of fertilizer applications. Reducing dust production helps in handling the fertilizer and increases the fertilizer's shelf-life. For all the improvements in coatings, however, there exists a continuing need for new coated fertilizers and new methods of making coated fertilizers that can provide for improvements in both dust control and controlled release.

### SUMMARY

The present disclosure provides coated fertilizer granule compositions that can provide for improvements in both dust control and controlled release. The coated fertilizer granule composition includes a fertilizer granule; a first polyurethane layer contacting the fertilizer granule to provide a first layer coating concentration on the fertilizer granule of 0.75 to 1.5 weight percent (wt. %) based on the total weight of the coated fertilizer granule composition, where the first polyurethane layer has an exterior surface; a second polyurethane layer at least partially covering the exterior surface of the first polyurethane layer to provide a second layer coating concentration of the second polyurethane layer of 0.75 to 1.5 wt. % based on the total weight of the coated fertilizer granule composition, where the first polyurethane layer and the second polyurethane layer provide a total coating concentration on the fertilizer granule of 1.5 to 3.0 wt. % based on the total weight of the coated fertilizer granule composition, and where each of the first polyurethane layer and the second polyurethane layer are separately formed from a reaction product of a reaction mixture that comprises a polyol mixture consisting of 40 to 60 wt. % of a 1,4-butanediol based on the total weight of the polyol mixture; and 60 to 40 wt. % of a propylene oxide-based polyether polyol having an equivalent weight of 700 to 1500 g/eq, the wt. % based on the total weight of the polyol mixture; a tertiary amine catalyst; and a polymethylene polyphenylisocyanate mixture comprising 8 to 20 wt. % of an ortho-para methylene diphenyl diisocyanate, where the wt. % is based on a total weight of the polymethylene polyphenylisocyanate mixture and provides the reaction mixture with an isocyanate index in a range from 90 to 200.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 illustrates a cross-sectional view of an example of a coated fertilizer granule composition in accordance with one or more embodiments of the present disclosure.

FIG. 2 illustrates a cross-sectional view of an example of a coated fertilizer granule composition in accordance with one or more embodiments of the present disclosure.

### DETAILED DESCRIPTION

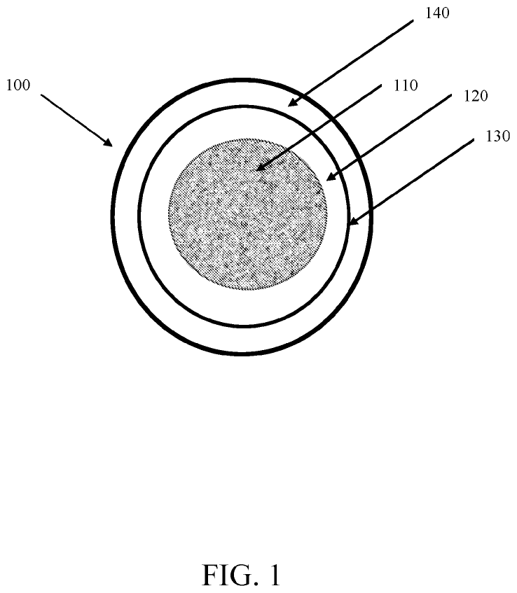

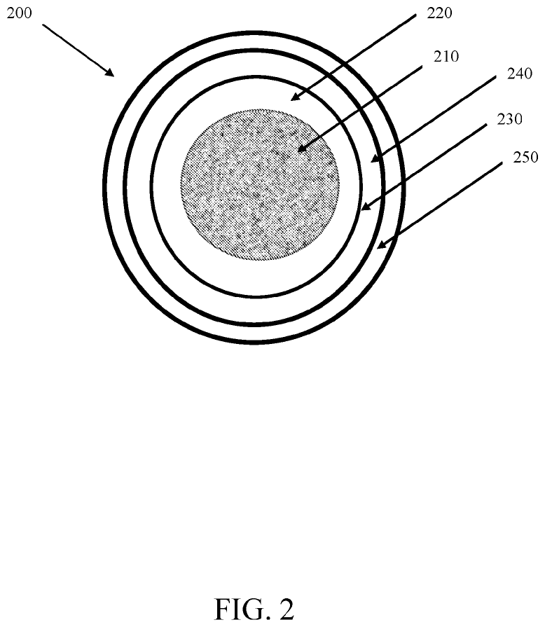

Coated fertilizer granule compositions (CFGCs) are disclosed herein. Advantageously, the CFGCs disclosed herein can provide for improved control of both fertilizer release and dust generation. Referring to FIG. 1, there is shown a cross-sectional view of an embodiment of a coated fertilizer granule composition (CFGC) 100 that includes a fertilizer granule 110; a first polyurethane layer 120 contacting the fertilizer granule 110, where the first polyurethane layer 120 has an exterior surface 130; a second polyurethane layer 140 at least partially covering the exterior surface 130 of the first polyurethane layer 120. Referring to FIG. 2, there is shown a cross-sectional view of an embodiment of a CFGC 200 that includes a fertilizer granule 210; a first polyurethane layer 220 contacting the fertilizer granule 210, where the first polyurethane layer 220 has an exterior surface 230; a second polyurethane layer 240 at least partially covering the exterior surface 230 of the first polyurethane layer 220; and a wax layer 250 at least partially covering the second polyurethane layer 240. Each of the above structures will now be discussed as follows, where the element numbers for the identical structures in FIG. 1 and FIG. 2 will be referred to simultaneously (e.g., the fertilizer granule 110/210; first polyurethane layer 120/220; the exterior surface 130/230 and the second polyurethane layer 140/240).

The CFGSs 100/200 disclosed herein include a fertilizer granule 110/210. The fertilizer granule 110/210 can be a homogonous or a blended granule that include one or more of urea, nitrogen, phosphorus, potassium sources such as ammonium nitrate, ammonium sulfate, ammonium sulfate nitrate, calcium nitrate, calcium ammonium nitrate, urea-formaldehyde, monoammonium phosphate, diammonium phosphate, polyphosphate compounds, phosphate rock, single superphosphate, triple super phosphate, potassium nitrate, potassium chloride, potassium sulfate, or combinations thereof, for instance. In some embodiments, the fertilizer granule 110/210 can comprise urea. For instance, the fertilizer granule 110/210 can have a nitrogen-phosphorus-potassium ratio of 46-0-0. The amounts of nitrogen, phosphorus, or potassium sources included in the fertilizer granule 110/210 can be varied based on the intended end use and can be 0 to 60 weight percent (wt. %) for each component, based on the total weight of the fertilizer granule 110/210.

Additionally, the fertilizer granule 110/210 can include magnesium sulfate with an optional source of one or more trace elements, where such trace elements can include micronutrients such as boron, calcium, chlorine, cobalt, copper, iron, manganese, molybdenum, nickel, sodium, zinc, or combinations thereof. These nutrients may be supplied in elemental form or in the form of salts, for example as sulfates, nitrates, or halides. The amount of micronutrients can depend on the intended end use and can be varied. For example, the amount of micronutrients can be from 0.1 to 5 wt. %, based on the total weight of the fertilizer granule 110/210. Fillers can also be utilized in the fertilizer granule 110/210, for example bentonite, calcite, calcium oxide, calcium sulfate (anhydrous or hemihydrate), dolomite, talc, sand, or a combination thereof may be utilized.

Other components of the fertilizer granule 110/210 can include, for example, surfactants, nucleation agents, or recycled fertilizer particles, which can act as a source of nucleating agents, nucleating soil conditioners such as calcium carbonate, activated carbon, elemental sulfur, biocides such as pesticides, herbicides, or fungicides, wicking agents, wetting agents, heat stabilizers, adhesives such as cellulose, polyvinyl alcohols, fats, oils, gum arabics, vinylidene ultraviolet stabilizers, antioxidants, reducing agents, colorants, binders, e.g., organochlorides, zeins, gelatins, chitosan, polyethylene oxide polymers, and acrylamide polymers and copolymers, and the like, as well as combinations thereof.

The fertilizer granules 110/210 can have a wide variety of shapes and/or sizes depending on their intended use. In some embodiments, the fertilizer granule 110/210 is substantially spherical. The fertilizer granules 110/210 can have an average particle diameter of 0.5 to 6.0 millimeters (mm). All individual values and subranges from 0.5 to 6.0 mm are included; for example, for the fertilizer granules 110/210 can have an average particle diameter from a lower limit of 0.5, 1.0, or 1.5 mm to an upper limit of 6.0, 5.5, or 5.0 mm. In some embodiments, at least 90% by weight of the fertilizer granules 110/120 have a particle diameter of 2.0 to 4.0 mm Particle diameter can be determined according to “Size Analysis-Sieve Method” IFDC S-107 issued by International Fertilizer Development Center (IFDC) which is a common and internationally approved method used to determine fertilizer particle size.

For the various embodiments, the CFGS 100/200 includes the first polyurethane layer 120/220 contacting the fertilizer granule 110/210, where the first polyurethane layer 120/220 has an exterior surface 130/230 and the second polyurethane layer 140/240 at least partially covers the exterior surface 130/230 of the first polyurethane layer 120/220. As used herein, the first polyurethane layer 120/220 contacting the fertilizer granule 110/210 includes at least partially covering from 80% to 100% of the surface area, e.g., the outermost area, of the fertilizer granule 110/210. All individual values and subranges from 80% to 100% are included; for example, for the first polyurethane layer 120/220 can cover from a lower limit of 80, 90, or 95% to an upper limit of 100, 99, or 98% of the surface area of the fertilizer granule 110/120. Similarly, as used herein, the second polyurethane layer 140/240 at least partially covering the exterior surface 130/230 of the first polyurethane layer 120/220 includes covering from 80% to 100% of the surface area, e.g., the outermost area, of the exterior surface 130/230 of the first polyurethane layer 120/220. All individual values and subranges from 80% to 100% are included; for example, for the second polyurethane layer 140/240 can cover from a lower limit of 80, 90, or 95% to an upper limit of 100, 99, or 98% of the exterior surface 130/230 of the first polyurethane layer 120/220.

For the given embodiments, the first polyurethane layer 120/220 and the second polyurethane layer 140/240 can provide a total coating concentration on the fertilizer granule 110/210 of 1.5 to 3.0 wt. % based on the total weight of the CFGC 100/200. For the total coating concentration on the fertilizer granule 110/210 all individual values and subranges from 1.5 to 3.0 wt. % are included herein; for example, the first polyurethane layer 120/220 and the second polyurethane layer 140/240 can provide a total coating concentration on the fertilizer granule 110/210 having a lower limit of 1.5, 1.6, 1.7, 1.75, 1.8, 1.85, 1.9, or 1.99 wt. % based on the total weight of the CFGC to an upper limit of 3.0, 2.75, 2.65, 2.55, 2.45, 2.35, 2.25, 2.15, 2.10, 2.05, or 2.01 wt. % based on the total weight of the CFGC 100/200.

For the various embodiments, the first polyurethane layer 120/220 contacting the fertilizer granule 110/210 provide a first layer coating concentration on the fertilizer granule 110/210 of 0.75 to 1.5 weight percent (wt. %) based on the total weight of the CFGC 100/200. For the various embodiments, all individual values and subranges of the first layer coating concentration on the fertilizer granule 110/210 of 0.75 to 1.5 wt. % are included herein; for example, the first polyurethane layer 120/220 can provide a first layer coating concentration on the fertilizer granule 110/210 from a lower limit of 0.75, 0.8, 0.85, 0.9, 0.95, or 0.99 wt. % to an upper limit of 1.5, 1.45, 1.40, 1.3, 1.25, 1.15, 1.10, 1.05, or 1.01 wt. % based on the total weight of the CFGC 100/200. For example, the first layer coating concentration of the first polyurethane layer 120/220 on the fertilizer granule 110/210 can be 0.9 to 1.1 wt. % based on the total weight of the CFGC. In an additional embodiment, the first layer coating concentration of the first polyurethane layer 120/220 can be 1.0 to 1.35 wt. % based on the total weight of the CFGC. In one embodiment, the first polyurethane layer 120/220 provides a first layer coating concentration on the fertilizer granule 110/210 of 1 wt. % based on the total weight of the CFGC.

For the various embodiments, the second polyurethane layer 140/240 at least partially covering the exterior surface 130/230 of the first polyurethane layer 120/220 provides a second layer coating concentration of the second polyurethane layer 140/240 of 0.75 to 1.5 wt. % based on the total weight of the CFGC. For the various embodiments, all individual values and subranges of the second layer coating concentration on the fertilizer granule 110/210 of 0.75 to 1.5 wt. % are included herein; for example, the second polyurethane layer 140/240 can provide a second layer coating concentration on the fertilizer granule 110/210 from a lower limit of 0.75, 0.8, 0.85, 0.9, 0.95, or 0.99 wt. % to an upper limit of 1.5, 1.45, 1.40, 1.3, 1.25, 1.15, 1.10, 1.05, or 1.01 wt. % based on the total weight of the CFGC 100/200. For example, the second layer coating concentration of the second polyurethane layer 140/240 on the fertilizer granule 110/210 can be 0.9 to 1.1 wt. % based on the total weight of the CFGC 100/200. In an additional embodiment, the second layer coating concentration of the second polyurethane layer 140/240 can be 1.0 to 1.35 wt. % based on the total weight of the CFGC 100/200. In one embodiment, the second polyurethane layer 140/240 provides a second layer coating concentration on the fertilizer granule 110/210 of 1 wt. % based on the total weight of the CFGC 100/200.

For the various embodiments, each of the first polyurethane layer 120/220 and the second polyurethane layer 140/240 are separately formed to provide each of the first polyurethane layer 120/220 and the second polyurethane layer 140/240 as discrete layers from a reaction product of a reaction mixture that comprises a polyol mixture, a tertiary amine catalyst and a polymethylene polyphenylisocyanate mixture (PPM). For the various embodiments, the first layer coating concentration of the first polyurethane layer 120/220 and the second layer coating concentration of the second polyurethane layer 140/240 for the CFGC 100/200 can be either the same or they can be different. Preferably, the first layer coating concentration of the first polyurethane layer 120/220 and the second layer coating concentration of the second polyurethane layer 140/240 for the CFGC 100/200 are the same. For example, as noted herein the first polyurethane layer 120/220 can provide a first layer coating concentration on the fertilizer granule 110/210 of 1 wt. % based on the total weight of the CFGC 100/200 and the second polyurethane layer 140/240 can provide a second layer coating concentration on the fertilizer granule 110/210 of 1 wt. % based on the total weight of the CFGC 100/200, where the first polyurethane layer 120/220 and the second polyurethane layer 140/240 provide a total coating concentration on the fertilizer granule 110/210 of 2 wt. % based on the total weight of the CFGC 100/200.

For the various embodiments, the reaction mixture can include, based on the total weight of the reaction mixture, 20 to 40 wt. % of the polyol mixture; 0.5 to 4 wt. % of the tertiary amine catalyst; and 56 to 79.5 wt. % of the PPM, where the wt. % values for the polyol mixture, the tertiary amine catalyst and the PPM total 100 wt. %. For the various embodiments, all individual values and subranges of the wt. % for each of the polyol mixture, the tertiary amine catalyst and the PPM are included herein. For Example, the reaction mixture can include, based on the total weight of the reaction mixture: the polyol mixture from a lower limit of 20, 25, 27.4 or 28 wt. % to an upper limit of 40, 35, or 30 wt. % based on the total weight of the reaction mixture; the tertiary amine catalyst from a lower limit of 0.5, 1.0, 2.0, 2.5, 2.9, or 3 wt. % to an upper limit of 4, 3.5, 3.2, 3.1, or 3.05 wt. % based on the total weight of the reaction mixture; and the PPM from a lower limit of 56, 60, 65, or 69 wt. % to an upper limit of 79.5, 75, 70 or 69.55 wt. % based on the total weight of the reaction mixture.

For the various embodiments, the reaction mixture used to form each of the first polyurethane layer 120/220 and the second polyurethane layer 140/240 can be identical. In other words, the same reaction mixture can be used to form both the first polyurethane layer 120/220 and the second polyurethane layer 140/240. In alternative embodiments, the reaction mixture used to form each of the first polyurethane layer 120/220 and the second polyurethane layer 140/240 can be different.

For the various embodiments, the polyol mixture consists of 40 to 60 wt. % of 1,4-butanediol (BDO) and 60 to 40 wt. % of a propylene oxide-based polyether polyol (Poly 1) having an equivalent weight of 700 to 1500 g/eq, where the wt. % values are based on the total weight of the polyol mixture. All individual values and subranges from 40 to 60 wt. % for the BDO and 60 to 40 wt. % of the Poly 1 are included herein. For example, the polyol mixture can contain from a lower limit of 40, 45, or 49 wt. % to an upper limit of 60, 57, 55, or 51 wt. % of BDO and a lower limit of 40, 45, or 49 wt. % to an upper limit of 60, 57, 55, or 51 wt. % of the Pol 1. In a specific embodiment, the polyol mixture, described herein, can consist of 45 to 55 wt. % of the BDO and 55 to 45 wt. % of the Poly 1. In an addition embodiment, the polyol mixture contains 50 wt. % of BDO and 50 wt. % of Pol 1. For the various embodiments, the wt. % values of the BDO and Poly 1 alone add to a total of 100 wt. % of the polyol mixture.

For the various embodiments, the BDO has a nominal, i.e., average, hydroxyl functionality from 1 to 4. All individual values and subranges from 1 to 4 are included; for example, the nominal hydroxyl functionality can be from a lower limit of 1, 1.5, or 1.8 to an upper limit of 4, 3.5, 3, or 2.2. Embodiments provide that the BDO has a nominal hydroxyl functionality of 2 or approximately 2. The BDO has an average hydroxyl number from 1100 to 1300 mg KOH/g. All individual values and subranges from 1100 to 1300 mg KOH/g are included; for example, the average hydroxyl number can be from a lower limit of 1100, 1150, 1200, or 1245 mg KOH/g to an upper limit of 1300, 1275, or 1250 mg KOH/g. Average hydroxyl number, as KOH, can be determined according to ASTM D4274. Embodiments provide that the BDO has an average hydroxyl number of 1245 mg KOH/g. The BDO has an equivalent weight from 35 to 55 g/eq. All individual values and subranges from 35 to 55 g/eq. are included; for example, the equivalent weight can be from a lower limit of 35, 40, or 45 g/eq. to an upper limit of 55, 50, or 46 g/eq. Embodiments provide that the BDO has an equivalent weight of approximately 45.06 g/eq.

For the various embodiments, the Poly 1 refers to a polyether polyol that is produced by polymerization of propylene oxide and optionally another alkylene oxide and an initiator. For the various embodiments, propylene oxide is 80 wt. % or more of the total alkylene oxide content of the Pol 1. Examples of other alkylene oxides that may be utilized in forming the Pol 1 include ethylene oxide, butylene oxide, and combinations thereof. For the various embodiments, the Pol 1 can be a trifunctional poly(propylene oxide) homopolymer polyether polyol. In addition, embodiments provide that the total alkylene oxide content used in forming the Pol 1 can be 80 to 100 wt. % of propylene oxide. All individual values and subranges from 80 to 100 wt. % are included; for example, the propylene oxide can be from a lower limit of 80, 90, or 95 wt. % to an upper limit of 100, 99, 98, or 97 wt. % of the total alkylene oxide content used in forming the Pol 1. One or more embodiments provide that propylene oxide is 100 wt. % of the total alkylene oxide content used in forming the Pol 1 (i.e., other alkylene oxides are not utilized). Examples of the initiator include water, glycerine, ethylene glycol, propylene glycol, trimethylolpropane, pentaerythritol or combinations thereof. The initiator can have functionality of 2 to 4.

The Pol 1 has a nominal, i.e., average, hydroxyl functionality of 2 to 4. All individual values and subranges from 2 to 4 are included; for example, the Pol 1 can have a nominal hydroxyl functionality from a lower limit of 2.0, 2.5, or 2.8 to an upper limit of 4.0, 3.5, or 3.2. One or more embodiments provide the Pol 1 has a nominal hydroxyl functionality of 3. The Pol 1 can be prepared using known equipment, reaction conditions, and reaction components. The Pol 1 can be obtained commercially. An example of commercially available propylene oxide-based polyether polyols includes, but is not limited to, propylene oxide-based polyether polyols sold under the trade name VORANOL™, such as VORANOL™ 230-056, available from DOW®.

The Pol 1 can have an average hydroxyl number from 10 to 100 mg KOH/g. All individual values and subranges from 10 to 100 mg KOH/g are included; for example, the Pol 1 can have an average hydroxyl number from a lower limit of 10, 20, 30, 40, 50, or 54 mg KOH/g to an upper limit of 100, 95, 85, 75, 65, or 58 mg KOH/g. Average hydroxyl number, as KOH, can be determined according to ASTM D4274. One or more embodiments provide that the Pol 1 has an average hydroxyl number from 54.5 to 57.5 mg KOH/g. The Pol 1 has an equivalent weight from 800 to 1200 g/eq. All individual values and subranges from 800 to 1200 g/eq. are included; for example, the equivalent weight can be from a lower limit of 800, 850, 900, 950, or 1000 g/eq. to an upper limit of 1200, 1150, 1100, 1050, or 1003 g/eq. In one embodiment, the Pol 1 has an equivalent weight of approximately 1002 g/eq. In an additional embodiment, the Pol 1 can be a trifunctional poly(propylene oxide) homopolymer polyether polyol having an equivalent weight of 800 to 1200 g/eq.

For the various embodiments, the tertiary amine catalyst can be selected from the group consisting of triethanolamine, triisopropanolamine, N-methyl-diethanolamine, N-ethyl-diethanolamine, N,N-dimethyl-ethanolamine and combinations thereof.

For the various embodiments, the PPM comprises 8 to 20 wt. % of an ortho-para methylene diphenyl diisocyanate (o,p′-MDI), where the wt. % is based on a total weight of the PPM and provides the reaction mixture with an isocyanate index in a range from 90 to 200. All individual values and subranges of the PPM comprising 8 to 20 wt. % of the o,p′-MDI are included herein. For example, the PPM can have a lower limit of the o,p′-MDI of 8, 9, 10, or 11 wt. % based on total weight of the PPM and an upper limit of the o,p′-MDI of 20, 18, 15, or 12 wt. % based on total weight of the PPM.

For the various embodiments, the PPM has an isocyanate functionality of at least 1.0. For instance, the PPM can have an isocyanate functionality from 1.0 to 5.0. All individual values and subranges from 1.0 to 5.0 are included; for example, the PPM can have an isocyanate functionality from a lower limit of 1.0, 1.5, or 2.0 to an upper limit of 5.0, 4.0, 3.5, 3.0, or 2.5.

For the given wt. % of the o,p′-MDI and the isocyanate functionality, the PPM can comprise 10 to 15 wt. % of the o,p′-MDI and an isocyanate functionality of 2 to 2.5.

The PPM for the various embodiments can further include an isocyanate index from 90 to 200. All individual values and subranges from 90 to 200 are included; for example, the PPM may provide an isocyanate index from a lower limit of 90, 100, 110, or 120 to an upper limit of 200, 190, 180, or 170. One or more embodiments provide that the PPM may provide an isocyanate index of 140. Isocyanate index may be determined as [isocyanate groups/active hydrogen groups×100]. Active hydrogen groups include those from the Pol 1, and the tertiary amine catalyst(s).

The PPM can have an equivalent weight 80 g/eq to 2000 g/eq. All individual values and subranges from 80 to 2000 g/eq are included; for example, the PPM can have an equivalent weight from a lower limit of 80, 90, 100, 115, 120, 130, or 133 to an upper limit of 2000, 1500, 1000, 500, 200 or 135, g/eq.

The PPM can have an NCO content from 20 to 45 wt. % based on a total weight of the PPM. All individual values and subranges from 20 to 45 wt. % are included; for example, the PPM can have an NCO a lower limit of 20, 25, 30, or 32 wt. % to an upper limit of 45, 40, 35, or 33 wt. % based on a total weight of the PPM.

Examples of a PPM having o,p′-MDI as provided herein include, but are not limited to, methylenediphenyl diisocyanate (MDI), polymeric MDI, polymethylene polyphenylisocyanate, and polymethylene polyphenylisocyanate containing MDI. The PPM may be prepared by a known process. The PPM may also be obtained commercially. Examples of commercial PPM include, but are not limited to, polyisocyanates under the trade name PAPI™, such as PAPI™ 94, available from DOW®, among other commercial isocyanates.

Embodiments of the present disclosure also include the following CFGCs based on the information provided herein. In one example of the CFGC 100/200, the first layer coating concentration is 0.9 to 1.1 wt. % based on the total weight of the CFGC 100/200; the second layer coating concentration is 0.9 to 1.1 wt. % based on the total weight of the CFGC 100/200, where the total coating concentration on the fertilizer granule 110/210 is 1.8 to 2.2 wt. % based on the total weight of the CFGC 100/200; the reaction mixture comprises: 25 to 30 wt. % the polyol mixture based on the total weight of the reaction mixture, where the polyol mixture consists of: 48 to 52 wt. % of the BDO; 48 to 52 wt. % of the trifunctional poly(propylene oxide) homopolymer polyether polyol having an equivalent weight of 900 to 1100 g/eq, wherein the wt. % are based on the total weight of the polyol mixture; 2.9 to 3.1 wt. % of the tertiary amine catalyst based on the total weight of the reaction mixture; and 65 to 75 wt. % of the PPM based on the total weight of the reaction mixture, where the PPM consists of 13 to 15 wt. % of the o,p′-MDI based on the total weight of the PPM. In another example of the CFGC 100/200, the first layer coating concentration of the first polyurethane layer 120/220 is 1.0 to 1.35 wt. % based on the total weight of the CFGC 100/200 and the second layer coating concentration of the second polyurethane layer 140/240 is 1.0 to 1.35 wt. % based on the total weight of the CFGC 100/200, where the total coating concentration on the fertilizer granule 110/210 is 2.0 to 2.7 wt. % based on the total weight of the CFGC 100/200. In a further example of the CFGC 100/200, the first layer coating concentration is 1 wt. % based on the total weight of the CFGC 100/200; the second layer coating concentration is 1 wt. % based on the total weight of the CFGC 100/200, where the total coating concentration on the fertilizer granule 110/210 is 2 wt. % based on the total weight of the CFGC 100/200; and where the reaction mixture comprises: 27.4 wt. % the polyol mixture based on the total weight of the reaction mixture, where the polyol mixture consists of: 50 wt. % of the 1,4-butanediol; 50 wt. % of the trifunctional poly(propylene oxide) homopolymer polyether polyol having an equivalent weight of 900 to 1100 g/eq, where the wt. % are based on the total weight of the polyol mixture; 3.05 wt. % of the tertiary amine catalyst based on the total weight of the reaction mixture; and 69.55 wt. % of the PPM based on the total weight of the reaction mixture, where the PPM consists of 14 wt. % of the o,p′-MDI based on the total weight of the PPM.

As previously discussed, and as seen in FIG. 2, the CFGC 200 of the present disclosure can further include a wax layer 250 that at least partially covering the second polyurethane layer 240. For the various embodiments, the second polyurethane layer 240 separates the wax layer 250 from the fertilizer granule 210 and the first polyurethane layer 220. In other words, each of the fertilizer granule 210, the first polyurethane layer 220 and the second polyurethane layer 240 and the are discrete from the wax layer 250.

For the various embodiments, the wax layer 250 at least partially covering the second polyurethane layer 240 to provide a wax layer concentration of 0.5 to 1.0 wt. % based on the total weight of the CFGC 200. In one embodiment, the wax layer 250 at least partially covering the second polyurethane layer 240 to provide a wax layer concentration of 0.5 wt. % based on the total weight of the CFGC 200.

Examples of the waxes that may be utilized for the wax layer 250 can include insect and animal waxes such as beeswax; vegetable waxes such as candelilla, carnauba, japan wax, ouricury waxes, Douglas-fir bark wax, rice-bran wax, jojoba, castor wax, and bayberry wax; mineral waxes such as montan wax, peat waxes, ozokerite and ceresin waxes, and petroleum waxes, e.g., paraffin wax, microcrystalline wax, semicrystalline wax; and synthetic waxes such as polyethylene wax, Fischer-Tropsch waxes, copolymer waxes of ethylene, propylene and/or acrylic acid, and mixture of petroleum wax with ethylene-vinyl acetate copolymer. In one group of embodiments, petroleum waxes and/or synthetic waxes are used. One or more embodiments provide that the wax is alpha olefin wax. The alpha olefin wax may be a straight chain hydrocarbon having from 20 to 40 carbons. For the various embodiments, the wax layer comprises a polyolefin wax layer having 20 to 40 carbon atoms and a dropping point of 60 to 70 degrees Celsius (C) as measured according to ASTM D3954.

Each of the first polyurethane layer 120/220, the second polyurethane layer 140/240 and the wax layer 250 of the CFGC 100/200 can be formed using known coating techniques. Such coating techniques include wet particle coating techniques in which the reaction mixture, as discussed herein, is applied to the fertilizer granules 110/210. In a general approach, the fertilizer granules 110/210 are heated in a heated drum coater to a temperature of 50 to 100° C. with mixing. Preferably, the fertilizer granules 110/210 are heated to 80° C. with mixing in the heated drum coater. Each of the first polyurethane layer 120/220 and the second polyurethane layer 140/240 are separately formed as follows.

To form the first polyurethane layer 120/220, a first portion (e.g., 50% by weight) of the PPM for forming the first polyurethane layer 120/220 is sprayed over the fertilizer granules 110/210 mixing in the heated drum coater. Once the first portion of the PPM is added to the fertilizer granules 110/210, the contents of the heated drum coater is allowed to mix for a first mixing interval of 1 to 10 minutes. After the first mixing interval, a mixture of the BDO, Pol 1 and the tertiary amine catalyst of the first polyurethane layer 120/220 is sprayed over the contents of the heated drum coater. The contents of the heated drum coater are allowed to mix for a second mixing interval of 1 to 10 minutes. After the second mixing interval, a second portion (e.g., 50% by weight) of the PPM for forming the first polyurethane layer 120/220 is sprayed over the contents of the heated drum coater, which is allowed to mix for a third mixing interval of 15 seconds to 5 minutes, thereby forming the first polyurethane layer 120/220.

To form the second polyurethane layer 140/240, a first portion (e.g., 50% by weight) of the PPM for forming the second polyurethane layer 140/240 is sprayed over the contents mixing in the heated drum coater. Once the first portion of the PPM is added, the contents mixing in the heated drum coater is allowed to mix for a fourth mixing interval of 15 seconds to 5 minutes. After the fourth mixing interval, a mixture of the BDO, Pol 1 and the tertiary amine catalyst of the second polyurethane layer 140/240 is sprayed over the contents of the heated drum coater. The contents of the heated drum coater is allowed to mix for a fifth mixing interval of 15 seconds to 5 minutes. After the fifth mixing interval, a second portion (e.g., 50% by weight) of the PPM for forming the second polyurethane layer 140/240 is sprayed over the contents of the heated drum coater, which is allowed to mix for a sixth mixing interval of 15 seconds to 5 minutes, thereby forming the second polyurethane layer 140/240. After forming the second polyurethane layer 140/240, the wax layer 250 can be added to the CFGC 100/200, if desired, by adding the wax in any of the amounts provided herein to the contents of the heated drum coater, which is allowed to mix for a seventh time interval of 1 to 6 minutes. After the seventh time interval, the heating to the heated drum coater can be turned off and the rotating contents of the drum coater can be allowed to cool naturally to 60° C., thereby forming the wax layer 250 as discussed herein. The contents of the drum coater can then be scooped from the drum coater and spread on a clean tray and allowed to cure at room temperature (23° C.) for, e.g., at least 7 days.

### EXAMPLES

### Materials

The following materials were used in the following Examples (Ex) and Comparative Examples (CE).

TABLE 1

| Ingredient | Description | Source |
|---|---|---|
| 1,4-butanediol (BDO) | Hydroxyl functionality of approximately 2; | UBE Corporation Europe, S.A. |
| | average hydroxyl number of 1245 mg KOH/g; | |
| | and equivalent weight of 45.06 g/eq. | |
| Polyol #1 (Pol. 1) | Glycerine-initiated trifunctional | Dow ® |
| Voranol ™ 230-056 Polyol | poly(propylene oxide) homopolymer | |
| | polyether polyol; hydroxyl number of 54.5- | |
| | 57.5 mg KOH/g; average equivalent weight of | |
| | 1002 g/eq; and nominal functionality of 3. | |
| Tertiary amine catalyst | Trifunctional, triethoxylated amine catalyst, | Dow ® |
| (Triethanolamine; TEA) | hydroxyl number of 1121 mg KOH/g. | |
| Wax (AlphaPlus ® C30 + HA) | Oligomeric polyolefin wax having at least 92 | Chevron Phillips Chemical |
| | wt. % C30 chains; dropping point | Company LLC |
| | 65.6° C. (ASTM D3954) | |
| Isocyanate 1 (PAPI ™ 94 | A polymethylene | Dow ® |
| Polymeric MDI) | polyphenylisocyanatecontaining methylene | |
| | diphenyl diisocyanate (MDI); Equivalent | |
| | weight of 133 g/eq, Nominal Functionality of | |
| | 2.3, Viscosity of 50 mPas (25° C., ASTM | |
| | D4889), o,p′-MDI % of 14 wt. % of MDI | |
| | fraction | |
| Isocyanate 2 (PAPI ™ 27 | A polymethylene | Dow ® |
| Polymeric MDI) | polyphenylisocyanatecontaining MDI; | |
| | Equivalent weight of 1331 g/eq; Nominal | |
| | Functionality of 2.7, Viscosity of 200 mPas (25° | |
| | C., ASTM D4889), o,p′-MDI % of 7 wt. % of | |
| | MDI fraction | |
| Fertilizer #1 Granules | Ammonium Sulfate (17-1-0) with | — |
| (Ammonia Sulfate based | approximately 20% sulfur and biosolid | |
| fertilizer) | content | |
| Fertilizer #2 Granules | Pure Granulated Urea (46-0-0) | American Plant Food Corp. |
| (Urea based fertilizer) | | |

### Examples and Comparative Examples of Coated Fertilizer Granule Compositions (CFGCs)

Table 2 provides the formulation percentages used in forming the Examples (Ex) and Comparative Examples (CE) with Fertilizer #1. Table 3 provides the formulation percentages used in forming the Examples (Ex) and Comparative Examples (CE) with Fertilizer #2. For Tables 2 and 3, the wt. % of the BDO and Pol. 1 seen in the polyurethane layer 1 (PU Layer 1) row and polyurethane layer 2 (PU Layer 2) row are based on the total weigh of the polyol mixture; the wt. % of the Isocyanate (1 or 2), BDO, Polyol 1, and TEA is based on the total weight of the reaction mixture used in forming the PU Layer 1 and PU layer 2; and the wt. % of the Total PU and Total Wax is based on the total weight of the CFGC for each of the Ex and CE.

TABLE 2
Coated Fertilizer Granule Composition (CFGC) for Fertilizer #1

| | Ex 1 | CE A | CE B | CE C | CE D | CE E | CE F |
|---|---|---|---|---|---|---|---|
| PU Layer 1 | BDO (50 | BDO | Pol. 1 | BDO (70 | BDO (30 | BDO (50 | BDO (50 |
| (wt. % based on | wt. %) + | (100 | (100 | wt. %) + | wt. %) + | wt. %) + | wt. %) + |
| total weight of | Pol. 1 | wt. %) | wt. %) | Pol. 1 (30 | Pol. 1 | Pol. 1 (50 | Pol. 1 |
| the polyol | (50 wt. %) | | | wt. %) | (70 wt. %) | wt. %) | (50 wt. %) |
| mixture) | | | | | | | |
| PU Layer 2 | BDO (50 | BDO | Pol. 1 | BDO (70 | BDO (30 | BDO | BDO (50 |
| (wt. % based on | wt. %) + | (100 | (100 | wt. %) + | wt. %) + Pol. 1 | (50%) + | wt. %) + |
| total weight of | Pol. 1 | wt. %) | wt. %) | Pol. 1 (30 | (70 wt. %) | Pol. 1 | Pol. 1 |
| the polyol | (50 wt. %) | | | wt. %) | | (50% wt. %) | (50 wt. %) |
| mixture) | | | | | | | |
| Wax Layer | Wax | Wax | Wax | Wax | Wax | Wax | Wax |
| Isocyanate 1 | 69.55 | 80.12 | 34.79 | 73.05 | 59.00 | 69.55 | — |
| (wt. %) | | | | | | | |
| Isocyanate 2 | — | — | — | — | — | — | 70.73 |
| (wt. %) | | | | | | | |
| BDO (wt. %) | 13.70 | 17.89 | — | 17.15 | 11.18 | 13.70 | 13.17 |
| Pol. 1 (wt. %) | 13.70 | — | 58.69 | 7.35 | 26.09 | 13.70 | 13.17 |
| TEA (wt. %) | 3.05 | 1.99 | 6.52 | 2.45 | 3.73 | 3.05 | 2.93% |
| Total PU (wt. %) | 2.00 | 2.00 | 2.00 | 2.00 | 2.00 | 2.70 | 2.00 |
| Total Wax | 0.50 | 0.50 | 0.50 | 0.50 | 0.50 | 0.50 | 0.50 |
| (wt. %) | | | | | | | |
| Total PU + Wax | 2.50 | 2.50 | 2.50 | 2.50 | 2.50 | 2.50 | 2.50 |
| (wt. %) | | | | | | | |
| Isocyanate | 140 | 140 | 140 | 140 | 140 | 140 | 140 |
| Index | | | | | | | |

TABLE 3
Coated Fertilizer Granule Composition for Fertilizer #2

| | Ex 2 | CE G | CE H | CE I | CE J |
|---|---|---|---|---|---|
| PU Layer 1 | BDO (50 wt. %) + | Pol. 1 (100 | BDO | BDO (25 wt. %) + | BDO (75 wt. %) + |
| (wt. % based on total | Pol. 1 (50 wt. %) | wt. %) | (100 | Pol. 1 (75 wt. %) | Pol. 1 (25 wt. %) |
| weight of the polyol | | | wt. %) | | |
| mixture) | | | | | |
| PU Layer 2 | BDO (50 wt. %) + | Pol. 1 (100 | BDO | BDO (75 wt. %) + | BDO (25 wt. %) + |
| (wt. % based on total | Pol. 1 (50 wt. %) | wt. %) | (100 | Pol. 1 (25 wt. %) | Pol. 1 (75 wt. %) |
| weight of the polyol | | | wt. %) | | |
| mixture) | | | | | |
| Wax Layer | Wax | Wax | Wax | Wax | Wax |
| Isocyanate 1 (wt. %) | 70 | 53 | 80 | 59 | 76 |
| BDO (wt. %) | 13.5 | — | 18 | 9.2 | 16.2 |
| Pol. 1 (wt. %) | 13.5 | 42.3 | — | 27.7 | 5.4 |
| TEA (wt. %) | 3 | 4.71 | 2 | 4.1 | 2.4 |
| Total PU (wt. %) | 2.70 | 2.70 | 2.70 | 2.70 | 2.70 |
| Total Wax (wt. %) | 0.50 | 0.50 | 0.50 | 0.50 | 0.50 |
| Total PU + Wax (wt. %) | 3.20 | 3.20 | 3.20 | 3.20 | 3.20 |
| Isocyanate Index | 140 | 140 | 140 | 140 | 140 |

The Ex and CE from Tables 2 and 3 are prepared using a drum roller process with a cylindrical, steel drum roller that is 16⅛″ in diameter and 5⅛″ deep with a 9⅜″ diameter circular open face plate and five evenly spaced ½″ bevels. For each Ex and CE, one kilogram (Kg) of the fertilizer granules is dried in an oven at 80° C. for at least 6 hours prior to starting the coating process. For the coating process, the drum coater is preheated to 70° C. The oven dried fertilizer (1 Kg for the given Ex or CE) is added to the heated drum coater after which the rotation of the drum coater is set to 35 rotations per minute (rpm). The drum coater temperature is then increased to heat and maintain the fertilizer granules in the drum coater at 80° C. for the coating process described herein, where the temperature is continuously monitored using an infrared thermometer.

The amounts of the ingredients used in forming each of the polyurethane layers for the Ex and CE are measured into a syringe using an analytic balance according to Table 4 for Fertilizer #1 and Table 5 for Fertilizer #2.

TABLE 4
Coated Fertilizer Granule Composition for Fertilizer #1

| Ex | CE | CE | CE | CE | CE | CE |
|---|---|---|---|---|---|---|
| 1 | A | B | C | D | E | F |

First Polyurethane Layer

| | | | | | | | |
|---|---|---|---|---|---|---|---|
| Isocyanate 1 | 2.78 g | 1.6 g | 1.39 g | 3.0 g | 4.45 g | 3.76 g | — |
| Isocyanate 2 | — | — | — | — | — | — | 2.8 g |
| BDO | 1.37 g | 0.89 g | — | 1.76 g | 1.16 g | 1.85 g | 1.35 g |
| Pol. 1 | 1.37 g | — | 5.87 g | 0.75 g | 2.71 g | 1.85 g | 1.35 g |
| TEA | 0.30 g | 0.10 g | 0.25 g | 0.39 g | 0.41 g | 0.30 g | 0.30 g |
| Isocyanate 1 | 4.17 g | 2.4 g | 2.08 g | 4.49 g | 3.68 g | 5.63 g | — |
| Isocyanate 2 | — | — | — | — | — | — | 3.0 g |

Second Polyurethane Layer

| | | | | | | | |
|---|---|---|---|---|---|---|---|
| Isocyanate 1 | 2.78 g | 1.6 g | 1.39 g | 3.0 g | 2.45 g | 3.7 g | — |
| Isocyanate 2 | — | — | — | — | — | — | 2.8 g |
| BDO | 1.37 g | 0.89 g | 1 | 1.76 g | 1.16 g | 1.85 g | 1.35 g |
| Pol. 1 | 1.37 g | — | 5.87 g | 0.75 g | 2.71 g | 1.85 g | 1.35 g |
| TEA | 0.30 g | 0.10 g | 0.25 g | 0.39 g | 0.41 g | 0.30 g | 0.30 g |
| Isocyanate 1 | 4.17 g | 2.4 g | 2.08 g | 4.49 g | 3.68 g | 5.63 g | — |
| Isocyanate 2 | — | — | — | — | — | — | 3.0 g |

Wax Layer

| | | | | | | | |
|---|---|---|---|---|---|---|---|
| Wax | 5 g | 5 g | 5 g | 5 g | 5 g | 5 g | 5 g |

TABLE 5
Coated Fertilizer Granule Composition for Fertilizer #2

| | Ex 2 | CE G | CE H | CE I | CE J |
|---|---|---|---|---|---|
| Isocyanate 1 | 3.76 g | 2.86 g | 4.32 g | 3.19 g | 4.10 g |
| Isocyanate 2 | — | — | — | — | — |
| BDO | 1.85 g | — | 2.43 | 1.24 g | 2.19 g |
| Pol. 1 | 1.85 g | 5.72 | — | 3.73 g | 0.73 g |
| TEA | 0.41 g | 0.64 g | 0.27 g | 0.55 g | 0.32 g |
| Isocyanate 1 | 5.64 g | 4.29 g | 6.48 g | 4.78 g | 6.16 g |
| Isocyanate 2 | — | — | — | — | — |
| Isocyanate 1 | 3.76 g | 2.86 g | 4.32 g | 3.19 g | 4.10 g |
| Isocyanate 2 | — | — | — | — | — |
| BDO | 1.85 g | — | 2.43 | 1.24 g | 2.19 g |
| Pol. 1 | 1.85 g | 5.72 | — | 3.73 g | 0.73 g |
| TEA | 0.41 g | 0.64 g | 0.27 g | 0.55 g | 0.32 g |
| Isocyanate 1 | 5.64 g | 4.29 g | 6.48 g | 4.78 g | 6.16 g |
| Isocyanate 2 | — | — | — | — | — |
| Wax | 5 g | 5 g | 5 g | 5 g | 5 g |

When the temperature of the fertilizer granules in the drum coater have reached 80° C. the ingredients that form the first polyurethane layer and the second polyurethane layer according to Table 3 are injected into the rotating fertilizer granules in the sequence and for the coating times provided in Table 6. Each of the BDO (when present), the Pol. 1 (when present) and the TEA for each of the polyurethane layers is injected as a mixture.

TABLE 6

| | Sequential Addition of | Coating time |
|---|---|---|
| | Ingredient(s) | (seconds) |
| First Polyurethane Layer | Isocyanate 1 or Isocyanate 2 | 120 |
| | BDO + Pol. 1 + TEA | 120 |
| | Isocyanate 1 or Isocyanate 2 | 30 |
| Second Polyurethane Layer | Isocyanate 1 or Isocyanate 2 | 30 |
| | BDO + Pol. 1 + TEA | 30 |
| | Isocyanate 1 or Isocyanate 2 | 30 |

After the coating of the second polyurethane layer is complete, the wax layer is then formed by adding the amount of wax provided in Table 3 to the contents of the drum coater. The drum coater is allowed to operate for 180 seconds to form the wax layer, after which time the drum coater heating is turned off and the rotating contents of the drum coater are allowed to cool naturally to 60° C. The contents of the drum coater scooped from the drum coater and spread on a clean tray and allowed to cure at room temperature (23° C.) for 7 days prior to being tested as described herein.

### Testing of Coated Fertilizer Granules

### Dust Measurement

Ex 1 and CE A-CE F were tested for dust attrition as follows. The dust attrition measurements are carried out using a milling jar (a tall two liter hydration bottle made of stainless-steel) in an EDEMET ball mill. 4.75 mm steel bearings were used as the grinding media. The details of the grinding chamber, along with the amounts of the different materials used in the dust attrition test are shown in Table 7.

TABLE 7
Conditions for Dust Attrition Tests

| | |
|---|---|
| Milling jar volume (L) | 2 |
| Diameter of milling jar (mm) | 119 |
| Test Sample of CFGC (g) | 100 |
| Grinding media (g) | 1930 |
| Diameter of grinding media (mm) | 4.75 |
| Rotational speed of ball mill (rpm) | 79 |
| Time of attrition testing (min) | 30 |

The dust attrition test was conducted as follows. Use a mesh #20 (850 micrometer straight weave openings) screen to remove pre-existing fines from a test sample of the CFGC. After screening, riffle the test sample of the CFGC with a chute riffle multiple times to acquire about 100 grams of the CFGC. Use an analytical balance to measure the mass of the test sample of the CFGC, mᵢ, and the mass of the clean grinding media, mg, as provided in Table 7. The test sample and the grinding media are added to the milling jar. The milling jar is placed on the ball mill, which is set to a speed of 70 rotations per minute (rpm). The milling jar is allowed to rotate at 70 rpm for 30 minutes. After 30 minutes, the content of the milling jar was unloaded into the top screen of a stack of three screens having the following order from top to bottom: mesh #5(4000 micrometer straight weave openings) screen; mesh #20 (850 micrometer straight weave openings) screen; and mesh #140 (105 micrometer straight weave openings) screen. The stack of three screens were manually shook for five minutes, after which the mass of material retained in each screen was measured using an analytic balance. Calculate the total dust attrition for the test sample of the CFGC according to Equation (1), where m₂₀ is the mass retained on the mesh #20 screen.

$$\% total dust = \frac{mi - {m}_{20}}{mi} \qquad Equation ( 1 )$$

The results of the dust attrition test for Ex 1 and CE A-CE F are reported in Table 8.

### Accelerated Release

The accelerated release of the coated fertilizer #1 is measured by immersing the coated fertilizer in water at 23° C. with a dimethylformamide (DMF) buffer solution to promote the release of the ammonium sulfate contained within the coated fertilizer sample. The IR absorbance for ammonium sulfate was recorded as a function of time using a Thermo Nicolet 6700 FTIR spectrometer. Intensities for ammonium sulfate at 1100 cm⁻¹ and Dimethylformamide (DMF) at 1650 cm⁻¹ were recorded. DMF is used as an internal standard for normalization.

The results of the accelerated release for Ex 1 and CE A-CE F are reported in Table 8.

TABLE 8

| | Ex | CE | CE | CE | CE | CE | CE |
|---|---|---|---|---|---|---|---|
| | 1 | A | B | C | D | E | F |
| Dust (% total dust) | 0.01 | 0.11 | 0.05 | 0.05 | 0.04 | 0.35 | 0.06 |
| Accelerated Fertilizer Release @ | 12 | 14 | 27 | 17 | 19 | 13 | 13 |
| 60 minutes (% Release) | | | | | | | |

The data of Table 8 illustrate that Ex 1 advantageously provided improved, e.g., reduced, fertilizer release at 60 minutes and increased dust control as compared to each of CE A-CE F.

### Controlled Release

The controlled release of the coated fertilizer #2 is measured as follows. Ten grams (g) of coated fertilizer #2 is placed into 100 milliliters (mL) of distilled water. The refractive index of the mixture was measured with a Reichert Technologies AR200 Handheld Refractometer at 14 and 28 days. The percent release was calculated using equation (2), where Y=refractive index. Each sample was tested three times and the average percent release for each sample was recorded.

$$\% Release = \frac{Y - 1.333}{0.0013} \qquad Equation ( 2 )$$

The results of the controlled release for Ex 2 and CE G-CE J are reported in Table 9.

TABLE 9

| Composition | Ex. 2 | CE G | CE H | CE I | CE J |
|---|---|---|---|---|---|
| % Release @ 14 d | 7% | 68% | 40% | 26% | 35% |
| % Release @ 28 d | 18% | 83% | 52% | 43% | 50% |

The data of Table 9 illustrate that Ex 2 provides improved controlled release of fertilizer at both day 14 and at day 28 as compared to each of Comparative Examples G-J.

1. A coated fertilizer granule composition comprising:
a fertilizer granule;
a first polyurethane layer contacting the fertilizer granule to provide a first layer coating concentration on the fertilizer granule of 0.75 to 1.5 weight percent (wt. %) based on the total weight of the coated fertilizer granule composition, wherein the first polyurethane layer has an exterior surface;
a second polyurethane layer at least partially covering the exterior surface of the first polyurethane layer to provide a second layer coating concentration of the second polyurethane layer of 0.75 to 1.5 wt. % based on the total weight of the coated fertilizer granule composition, wherein the first polyurethane layer and the second polyurethane layer provide a total coating concentration on the fertilizer granule of 1.5 to 3.0 wt. % based on the total weight of the coated fertilizer granule composition, and wherein:
each of the first polyurethane layer and the second polyurethane layer are separately formed from a reaction product of a reaction mixture that comprises:
a polyol mixture consisting of:
40 to 60 weight percent (wt. %) of a 1,4-butanediol based on the total weight of the polyol mixture; and
60 to 40 wt. % of a propylene oxide-based polyether polyol having an equivalent weight of 700 to 1500 g/eq, the wt. % based on the total weight of the polyol mixture;
a tertiary amine catalyst; and
a polymethylene polyphenylisocyanate mixture comprising 8 to 20 wt. % of an ortho-para methylene diphenyl diisocyanate, wherein the wt. % is based on a total weight of the polymethylene polyphenylisocyanate mixture and provides the reaction mixture with an isocyanate index in a range from 90 to 200.

2. The coated fertilizer granule composition of claim 1, wherein the polyol mixture consists of 45 to 55 wt. % of the 1,4-butanediol and 55 to 45 wt. % of the propylene oxide-based polyether polyol.

3. The coated fertilizer granule composition of claim 1, wherein the propylene oxide-based polyether polyol is a trifunctional poly(propylene oxide) homopolymer polyether polyol having an equivalent weight of 800 to 1200 g/eq.

4. The coated fertilizer granule composition of claim 1, wherein the polymethylene polyphenylisocyanate mixture comprising 10 to 15 wt. % of the ortho-para methylene diphenyl diisocyanate and an isocyanate functionality of 2 to 2.5.

5. The coated fertilizer granule composition of claim 1, wherein, based on the total weight of the reaction mixture, the reaction mixture comprises:
20 to 40 wt. % of the polyol mixture;
0.5 to 4 wt. % of the tertiary amine catalyst; and
56 to 79.5 wt. % of the polymethylene polyphenylisocyanate mixture, wherein the wt. % values for the polyol mixture, the tertiary amine catalyst and the polymethylene polyphenylisocyanate mixture total 100 wt. %.

6. The coated fertilizer granule composition of claim 1, wherein:
the first layer coating concentration is 0.9 to 1.1 wt. % based on the total weight of the coated fertilizer granule composition;
the second layer coating concentration is 0.9 to 1.1 wt. % based on the total weight of the coated fertilizer granule composition, wherein the total coating concentration on the fertilizer granule is 1.8 to 2.2 wt. % based on the total weight of the coated fertilizer granule composition;
and wherein the reaction mixture comprises:
25 to 30 wt. % the polyol mixture based on the total weight of the reaction mixture, wherein the polyol mixture consists of:
48 to 52 wt. % of the 1,4-butanediol;
48 to 52 wt. % of the trifunctional poly(propylene oxide) homopolymer polyether polyol having an equivalent weight of 900 to 1100 g/eq, wherein the wt. % are based on the total weight of the polyol mixture;
2.9 to 3.1 wt. % of the tertiary amine catalyst based on the total weight of the reaction mixture; and
65 to 75 wt. % of the polymethylene polyphenylisocyanate mixture based on the total weight of the reaction mixture, wherein
the polymethylene polyphenylisocyanate mixture consists of 13 to 15 wt. % of the ortho-para methylene diphenyl diisocyanate based on the total weight of the polymethylene polyphenylisocyanate mixture.

7. The coated fertilizer granule composition of claim 1, wherein the first layer coating concentration of the first polyurethane layer is 1.0 to 1.35 wt. % based on the total weight of the coated fertilizer granule composition and the second layer coating concentration of the second polyurethane layer is 1.0 to 1.35 wt. % based on the total weight of the coated fertilizer granule composition, wherein the total coating concentration on the fertilizer granule is 2.0 to 2.7 wt. % based on the total weight of the coated fertilizer granule composition.

8. The coated fertilizer granule composition of claim 1, further including a wax layer at least partially covering the second polyurethane layer to provide a wax layer concentration of 0.5 to 1.0 wt. % based on the total weight of the coated fertilizer granule composition.

9. The coated fertilizer granule composition of claim 1, wherein:
the first layer coating concentration is 1 wt. % based on the total weight of the coated fertilizer granule composition;
the second layer coating concentration is 1 wt. % based on the total weight of the coated fertilizer granule composition, wherein the total coating concentration on the fertilizer granule is 2 wt. % based on the total weight of the coated fertilizer granule composition;
and wherein the reaction mixture comprises:
27.4 wt. % the polyol mixture based on the total weight of the reaction mixture, wherein the polyol mixture consists of:
50 wt. % of the 1,4-butanediol;
50 wt. % of the trifunctional poly(propylene oxide) homopolymer polyether polyol having an equivalent weight of 900 to 1100 g/eq, wherein the wt. % are based on the total weight of the polyol mixture;
3.05 wt. % of the tertiary amine catalyst based on the total weight of the reaction mixture; and
69.55 wt. % of the polymethylene polyphenylisocyanate mixture based on the total weight of the reaction mixture, wherein the polymethylene polyphenylisocyanate mixture consists of 14 wt. % of the ortho-para methylene diphenyl diisocyanate based on the total weight of the polymethylene polyphenylisocyanate mixture;
and further comprising:
a wax layer at least partially covering the second polyurethane layer to provide a wax layer concentration of 0.5 wt. % based on the total weight of the coated fertilizer granule composition.

10. The coated fertilizer granule composition of claim 8, wherein the wax layer comprises a polyolefin wax layer having 20 to 40 carbon atoms and a dropping point of 60 to 70 degrees Celsius (° C.) as measured according to ASTM D3954.
